(19) United States
(12) Patent Application Publication
(10) Pub. No.: US 2013/0151469 A1
(43) Pub. Date: Jun. 13, 2013

(54) DATA SYNCHRONIZATION LATENCY INDICATOR

(71) Applicants: Paul Baker, Eastleigh (GB); Alexander J. Ralph, Bradford-on-Avon (GB)

(72) Inventors: Paul Baker, Eastleigh (GB); Alexander J. Ralph, Bradford-on-Avon (GB)

(73) Assignee: MOTOROLA MOBILITY, INC., Libertyville, IL (US)

(21) Appl. No.: 13/316,051

(22) Filed: Dec. 9, 2011

(51) Int. Cl. G06F 7/00

(52) U.S. Cl. 707/621; 707/E17.005; 707/E17.032

(57) ABSTRACT

A method and apparatus for displaying an indication of a synchronization delay for a portable computing device is disclosed. The synchronization latency describes the time separating data exchanges between the portable computing device and a server. The portable computing device determines the synchronization latency and generates a synchronization latency indicator providing a visional representation of the synchronization latency. The synchronization latency indicator is then displayed. For example, a count down timer depicting the interval from a current time to a data exchange with the server is displayed or an image is modified as the time from the current time to a data exchange with the server decreases.

### FIELD OF THE DISCLOSURE

The present disclosure relates generally to portable computing devices and more particularly to displaying an indication of data synchronization latency for a portable computing device.

### BACKGROUND

Portable computing devices, such as smartphones or tablet computers, have become increasingly powerful and user-friendly. Increased network connectivity has further enhanced portable computing device functionality, allowing portable computing devices to provide a wider range of functionalities and/or data. For example, portable computing devices are commonly used to retrieve, or otherwise interact with, data stored or maintained by a server, allowing a user to more frequently view, modify or otherwise interact with data on the server.

To readily provide access to data maintained by a server, a portable computing device frequently exchanges data with the server to synchronize data stored on the portable computing device and data stored on the server. Different data synchronization settings may be used by the portable computing device to exchange data with a server. For example, the portable computing device may poll the server at a regular polling interval to transmit data to the server or retrieve data from the server. Alternatively, data may be pushed from the portable computing device to a server, or from a server to the portable computing device, at a periodic interval.

However, the time between exchanges of data between a portable computing device and a server depends on several factors. For example, the type of synchronization used and the environment where the portable computing device is used affect the time delay between exchanges of data between the portable computing device and a server. While data exchanges between a portable computing device may occur at different time intervals based on one or more factors, users of conventional portable computing devices do not receive an indication of the expected time until data is exchanged between the portable computing device and a server and/or other data describing when the portable computing device is expected to exchange data with a server.

### BRIEF DESCRIPTION OF THE DRAWINGS

The accompanying Figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a computing system in accordance with some embodiments.

FIG. 2 is a block diagram of a portable computing device in accordance with some embodiments.

FIG. 3 is a flow chart of a method for displaying data synchronization latency for a portable computing device in accordance with some embodiments.

FIG. 4 is a flow chart of a method for determining data synchronization latency of a portable computing device in accordance with some embodiments.

FIG. 5 is an example of a user interface displaying data synchronization latency in accordance with some embodiments.

Skilled artisans will appreciate that elements in the Figures are illustrated for simplicity and clarity and have not necessarily been drawn to scale. For example, the dimensions of some of the elements in the Figures may be exaggerated relative to other elements to help to improve understanding of embodiments of the present invention.

The apparatus and method components have been represented where appropriate by conventional symbols in the drawings, showing the specific details that are pertinent to understanding the embodiments of the present invention so as not to obscure the disclosure with details that will be readily apparent to those of ordinary skill in the art having the benefit of the description herein.

### DETAILED DESCRIPTION

The following disclosure describes a method and apparatus for displaying an indication of a synchronization latency for a portable computing device exchanging data with a server. The synchronization latency describes the time separating data exchanges between the portable computing device and a server. The portable computing device determines the synchronization latency and generates a synchronization latency indicator providing a visional representation of the synchronization latency. The synchronization latency indicator is then displayed. For example, a count down timer or a count up timer depicting the interval from a current time to a data exchange with the server is displayed or an image is modified as the time from the current time to a data exchange with the server decreases.

In the following description, for purposes of explanation, numerous specific details are set forth to provide a thorough understanding of the invention. However, it will be apparent to one skilled in the art that the invention can be practiced without these specific details. In other instances, structures and devices are shown in block diagram form in order to avoid obscuring the invention.

### System Overview

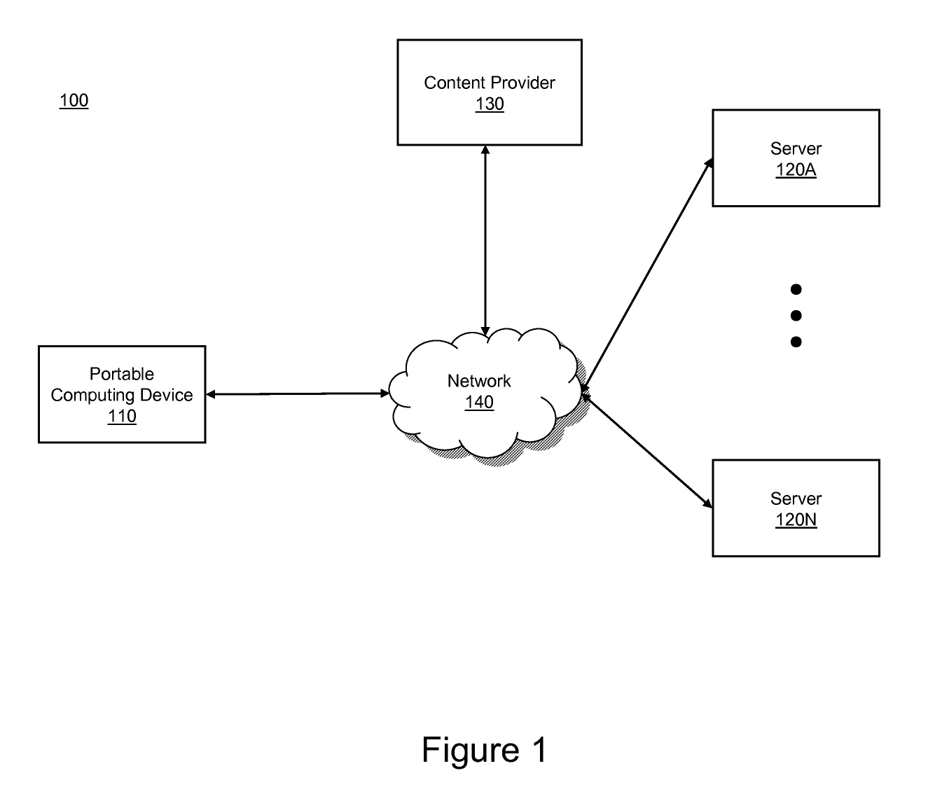

FIG. 1 is a block diagram of one embodiment of a computing system 100. In the embodiment shown by FIG. 1, the computing system 100 includes a portable computing device 110, one or more servers 120A, 120N (also referred to individually and collectively using reference number 120), a content provider 130 and a network 140. However, in different embodiments, the computing system 100 may include different and/or additional components than those depicted by FIG. 1.

The portable computing device 110 is any device with data processing and data communication capabilities. Examples of a portable computing device 110 include a smartphone, a tablet computer, a netbook computer, a laptop computer or any other suitable device. The portable computing device 110 receives data from one or more servers 120A, 120N and/or from a content provider 130 via the network 140. In one embodiment, the portable computing device 110 executes one or more applications exchanging data with one or more servers 120 or a content provider 130. For example, the portable computing device 110 executes an electronic mail (e-mail) client application exchanging data associated with one or more e-mail accounts with one or more servers 120. As another example, the portable computing device 110 executes a social networking application receiving social network data associated with an account from a server 120 and/or transmitting social network data associated with the account to the server 120.

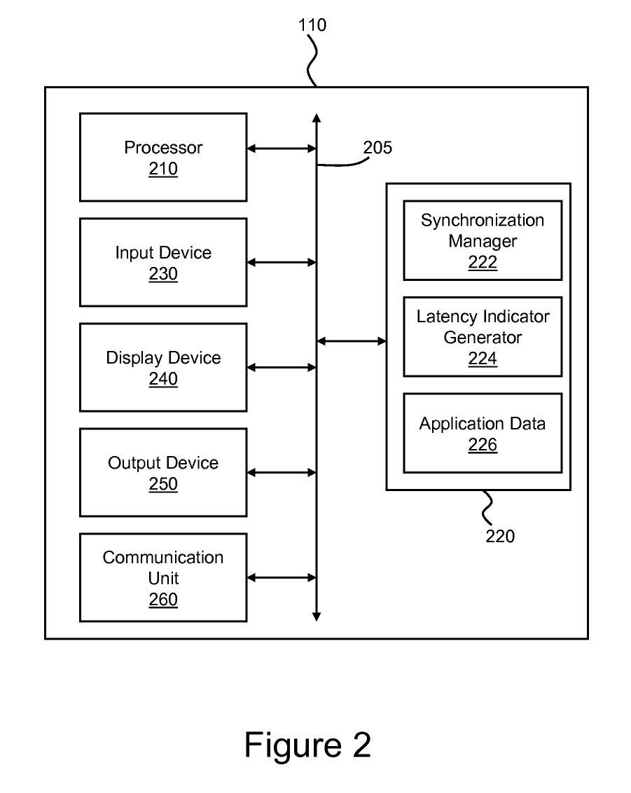

In one embodiment, the portable computing device 110 also receives executable data or instructions from a server 120 via the network 140 that, when executed by the portable computing device 110, executes an application enabling user interaction with content. Additionally, the portable computing device 110 may receive video content, image content or other content from a content provider 130 and present the received content to a user. For example, the portable computing device 110 displays video content from a content provider 130 on a display device. The portable computing device 110 is further described below in conjunction with FIG. 2.

Servers 120A, 120N are computing devices having data processing and data communication capabilities that exchange data with the portable computing device 110 via the network 140. For example, a server 120 provides data such as a web page, audio content, video content, e-mail, calendar information, social networking data or other content via the network 140 to the portable computing device 110 and/or receives data from a portable computing device 110 via the network 140. In one embodiment, a server 120 receives a polling request from the portable computing device 110 via the network 140 at a specified time interval and transmits data to the portable computing device 110 responsive to receiving the polling request or stores data from the portable computing device 110 included in the received polling request. In another embodiment, a server 120 pushes data to the portable computing device 110 using the network 140 at a specified interval.

The content provider 130 comprises one or more computing devices transmitting video content, image content, audio content or other content to the portable computing device 110 via a network 140. For example, the content provider 130 is a video hosting web site, a television provider or another source of video, image or audio content. As another example, the content provider 130 is a streaming video source transmitting streaming video content. In one embodiment, the content provider 130 exchanges data with the portable computing device 110 via the network 140 at predetermined intervals either by pushing content to the portable computing device 110 at periodic intervals or by transmitting data to the portable computing device 110 responsive to receiving a polling request from the portable computing device 110.

The network 140 is a conventional type for data, video and/or audio transmission. In various embodiments, the network 140 is a wired network, a wireless network or a combination of wireless and wired networks. The network 140 may have any number of configurations such as a star configuration, a token ring configuration or another configuration known in the art. Furthermore, the network 140 may comprise a local area network (LAN), a wide area network (WAN) (e.g., the Internet), and/or any other interconnected data path across which multiple devices may communicate. In yet another embodiment, the network 140 may be a peer-to-peer network. The network 140 may also be coupled to or include portions of a telecommunications network for sending data in a variety of different communication protocols, such as those used for Transmission Control Protocol/Internet Protocol (TCP/IP), satellite link and/or cable television communication. For example, the network 140 may transmit voice data using one or more of a Global System for Mobile (GSM) communication system, Code Division Multiple Access (CDMA) system, Universal Mobile Telecommunications System (UMTS) or any other suitable protocols.

The network 140 may also transmit data using one or more of General Packet Radio Service (GPRS), second-generation (2G), or greater, mobile network, third-generation (3G), or greater, mobile network, fourth-generation (4G), or greater, mobile network, High Speed Download Packet Access (HSDPA), High Speed Uplink Packet Access (HSUPA), Long-Term Evolution (LTE), Worldwide Interoperability for Microwave Access (WiMax) or any other suitable protocol. In yet another embodiment, the network 140 includes Bluetooth communication networks or a cellular communications network for sending and receiving data such as via short messaging service (SMS), multimedia messaging service (MMS), hypertext transfer protocol (HTTP), direct data connection, wireless application protocol (WAP), email or other types of data known in the art.

FIG. 2 is a block diagram of one embodiment of a portable computing device 110. In the embodiment shown by FIG. 2, the portable computing device 110 includes a processor 210, a storage device 220, an input device 230, a display device 240, an output device 250 and a communication unit 260 that are coupled together via a bus 205. However, in different embodiments, the portable computing device 110 may include different and/or additional components than those illustrated by FIG. 2.

The processor 210 processes data or instructions and may comprise various computing architectures. For example, the processor 210 processes data or instructions using a complex instruction set computer (CISC) architecture, a reduced instruction set computer (RISC) architecture, an architecture implementing a combination of instruction sets or any other suitable instruction set. Although FIG. 2 shows a single processor 210, in other embodiments, the portable computing device 110 may include multiple processors. The processor 210 transmits, processes and/or retrieves data from the storage device 220, the input device 230, the display device 240, the output device 250 and/or the communication unit 260.

The storage device 220 stores data and/or instructions that, when executed by the processor 210, cause the processor 210 to perform one or more actions or to provide one or more types of functionality. The data and/or instructions included in the storage device 220 may comprise computer-readable code that, when executed by the processor 210, performs one or more of the methods described herein and/or provide at least a subset of the functionality described herein. The storage device 220 may comprise a dynamic random access memory (DRAM), a static random access memory (SRAM), a hard disk, an optical storage device, a magnetic storage device, a Read Only Memory (ROM), a Programmable Read Only Memory (PROM), an Erasable Programmable Read Only Memory (EPROM), an Electrically Erasable Programmable Read Only Memory (EEPROM), a Flash memory or another memory device known in the art. The storage device 220 may be a persistent storage device, a non-persistent storage device or a combination of a persistent storage device and a non-persistent storage device in various embodiments. The storage device 220 is coupled to the processor 210, the input device 230, the display device 240, the output device 250 and the communication unit 260 via the bus 205.

In the embodiment shown by FIG. 2, the storage device 220 includes a synchronization manager 222, a latency indicator generator 224 and application data 226. In other embodiments, the storage device 220 may include different and/or additional components than those shown in FIG. 2. The synchronization manager 222 comprises instructions that, when executed by the processor 210, calculate data describing a synchronization latency in exchanging data between the portable computing device 110 and a server 120 and/or a content provider 130. In one embodiment, the synchronization manager 222 also modifies the frequency with which one or more applications executed by the portable computing device 110 exchange data with a server 120 or with a content provider 130. Additionally, the synchronization manager 222 may also calculate or determine the availability of the network 140 to the portable computing device 110. In one embodiment, the synchronization manager 222 determines an estimated time until the network 140 is available using data included in the storage device 220 describing network statistics.

Additionally, the synchronization manager 222 stores one or more synchronization settings describing a frequency with which the portable computing device 110 exchanges data with one or more servers 120. For example, the synchronization manager 222 includes a polling interval identifying a time between transmission of requests for data from the portable computing device 110 to a server 120 and/or to a content provider 130. As another example, the synchronization manager 222 includes instructions for establishing a push communication channel between the portable computing device 110 and a server 120 and/or a content provider 130 and may also identify when data is pushed between the server 120 or the content provider 130 using the push communication channel, such as a push interval or a description of events causing data to be pushed.

In one embodiment, the synchronization manager 222 associates an application identifier with one or more synchronization settings, allowing different applications executed by the portable computing device 110 to use different synchronization settings or to use multiple synchronization settings. When calculating the synchronization latency, the synchronization manager 222 uses the synchronization settings to determine the delay between data exchanges between the portable computing device 110 and a server 120 and/or a content provider 130. This allows the calculated synchronization latency to account for attributes of different data synchronization methods.

The latency indicator generator 224 comprises instructions that, when executed by the processor 210, generate a visual representation of the synchronization latency calculated by the synchronization manager 222 and retrieved by the latency indicator generator 224. In one embodiment, the latency indicator generator 224 generates a count down timer or a count up timer indicating the time until a data exchange between the portable computing device 110 and a server 120 or a content provider 130 from the calculated synchronization latency. In another embodiment, the latency indicator generator 224 generates an alternative representation of the calculated synchronization latency, such as an image changing in appearance as the time to a data exchange with a server 120 or with a content provider 130 decreases. Alternatively, the latency indicator generator 224 displays an alphanumeric indication of the time until a data exchange between the portable computing device 110 and the server 120 or the content provider 130 determined by synchronization latency. In yet another embodiment, the latency indicator generator 224 generates an audible tone or haptic feedback using the time until a data exchange between the portable computing device 110 and the server 120 or the content provider 130. For example, the latency indicator generator 224 causes an output device to generate a tone or provide haptic feedback when the time until a data exchange equals a threshold value.

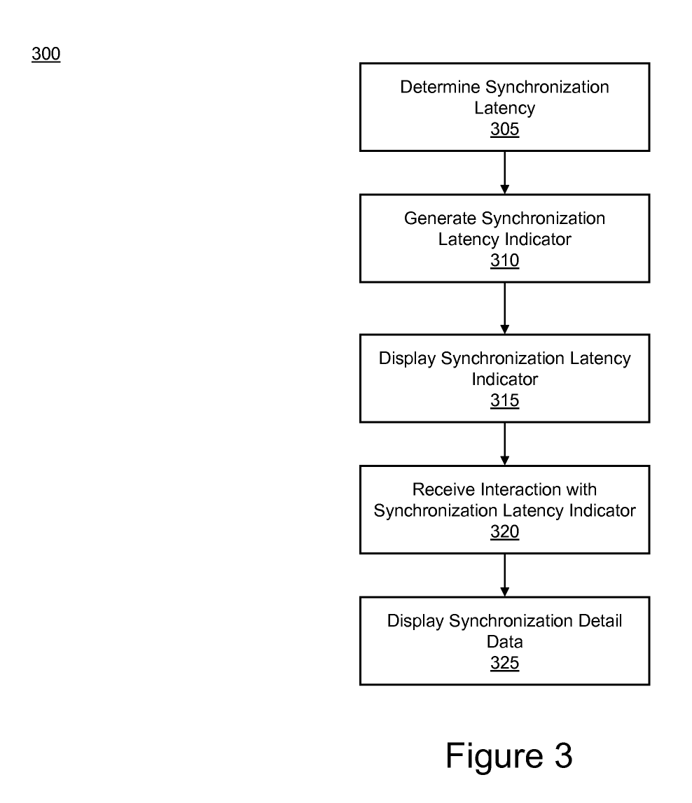

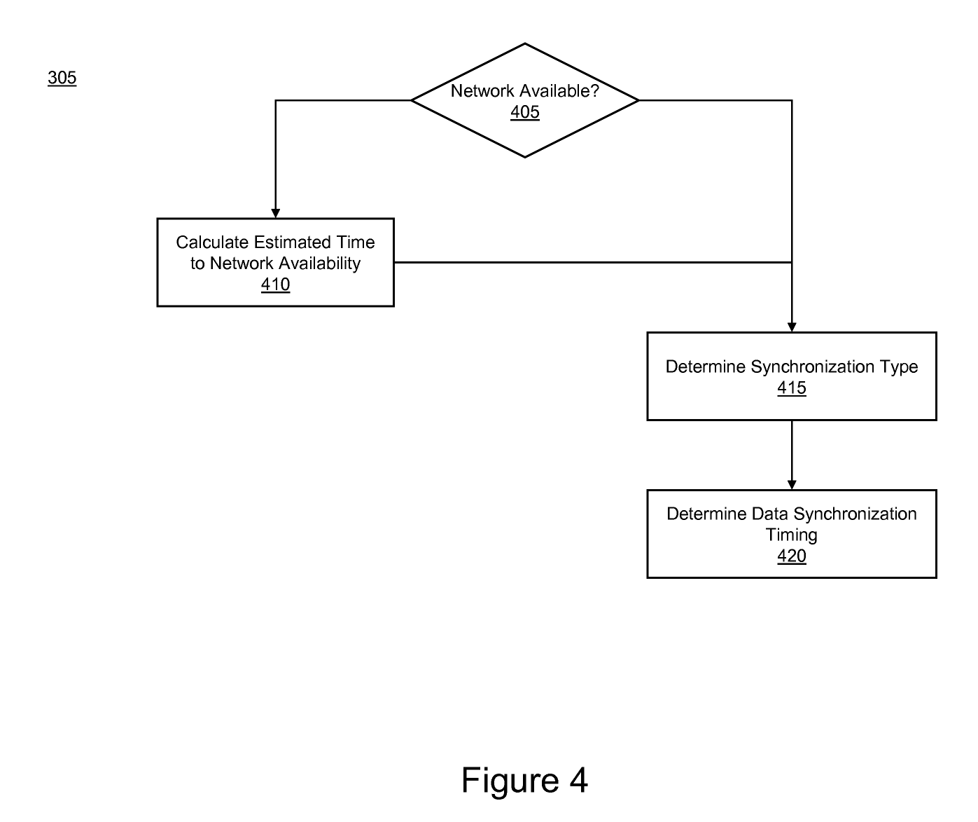

In some embodiments, the latency indicator generator 224 may display additional data synchronization information, such as the type of synchronization used, alternate types of synchronization or other suitable data. In one embodiment, the latency indicator generator 224 may also generate a synchronization initiator allowing a user of the portable computing device 110 to initiate a data exchange between the portable computing device 110 and a server 120 or a content provider 130 by interacting with the synchronization initiator. Operation of the synchronization manager 222 and the latency indicator generator 224 is further described below in conjunction with FIGS. 3 and 4.

The application data 226 comprises instructions that, when executed by the processor 210, implement one or more applications providing functionality to a user of the portable computing device 110 or to the portable computing device 110. For example, the application data 226 includes data for executing a web browser, an e-mail client, a social network viewer, a messaging application, a calendar, an image viewer, a text editor, a news aggregator or other application transmitting data to and/or receiving data from a server 120 or a content provider 130 via the network 140. In one embodiment, an application included in the application data 226 is associated with a synchronization interval stored by the synchronization manager 222 and exchanges data with a server 120 or a content provider 130 at time intervals specified by the synchronization interval.

The input device 230 is any device configured to receive input and to communicate the received input to the processor 210, to the storage device 220 or to another component of the portable computing device 110. For example, the input device 230 comprises a cursor controller, a touch-sensitive display or a keyboard. In one embodiment, the input device 230 includes an alphanumeric input device, such as a keyboard, a key pad, representations of such created on a touch-sensitive display or another device adapted to communicate information and/or commands to the processor 210 or to the storage device 220. In another embodiment, the input device 230 comprises a device for communicating positional data as well as data or commands to the processor 210 or to the storage device 220 such as a joystick, a mouse, a trackball, a stylus, a touch-sensitive display, directional keys or another suitable input device known in the art.

In one embodiment, the input device 230 may also include an orientation sensor determining an orientation associated with the portable computing device 110. For example, the orientation sensor comprises a tilt sensor measuring tilting in two or more axes of a reference plane. In one embodiment, the orientation sensor comprises an accelerometer determining an orientation of the portable computing device 110. The orientation sensor may generate a first control signal responsive to determining the portable computing device 110 has a first orientation and generates a second control signal responsive to determining the portable computing device 110 has a second orientation. For example, the orientation sensor generates the first control signal responsive to determining the portable computing device 110 has a first orientation relative to a reference plane and generates the second control signal responsive to determining the portable computing device 110 has a second orientation relative to the reference plane. For example, the orientation sensor generates the first control signal responsive to being perpendicular to a reference plane and generates the second control signal responsive to being parallel to the reference plane. In one embodiment, the first orientation and the second orientation are orthogonal to each other, such as a landscape orientation and a portrait orientation.

The display device 240 is a device that displays electronic images and/or data. For example, the display device 240 comprises an organic light emitting diode display (OLED), a liquid crystal display (LCD) or any other device such as a monitor. In one embodiment, the display device 240 includes a touch-sensitive transparent panel for receiving data or allowing other interaction with the images and/or data displayed by the display device 240.

The output device 250 comprises one or more devices that convey data or information to a user of the portable computing device 110. For example, the output device 250 includes one or more speakers or headphones for presenting audio data to a user. As another example, the output device 250 includes one or more light emitting diodes (LEDs) or other light sources to provide visual data to a user. As another example, the output device 250 includes one or more devices for providing vibrational, or haptic, feedback to a user. The above are merely examples and the output device 250 may include one or more devices for providing auditory output, tactile output, visual output, any combination of the preceding or any other suitable form of output.

The communication unit 260 transmits data from portable computing device 110 to the network 140 or to other portable computing devices 110 and/or receives data from a server 120 or a content provider 130 via the network 140. In one embodiment, the communication unit 260 comprises a wireless transceiver that transmits and/or receives data using one or more wireless communication protocols. For example, the communication unit 260 includes one or more wireless transceivers transmitting and/or receiving data using one or more wireless communication protocols, such as IEEE 802.11a/b/g/n (WiFi), Global System for Mobile (GSM), Code Division Multiple Access (CDMA), Universal Mobile Telecommunications System (UMTS), General Packet Radio Service (GPRS), second-generation (2G), or greater, mobile network, third-generation (3G), or greater, mobile network, fourth-generation (4G), or greater, mobile network, High Speed Download Packet Access (HSDPA), High Speed Uplink Packet Access (HSUPA), Long-Term Evolution (LTE), Worldwide Interoperability for Microwave Access (WiMax), near field communication (NFC), BLUETOOTH® or another wireless communication protocol. In another embodiment, the communication unit 260 is a network adapter or other type of wired communication port for communicating with the network 140 or with another portable computing device 110 using a wired communication protocol, such as Universal Serial Bus (USB), Ethernet or another suitable wired communication protocol. In yet another embodiment, the communication unit 260 comprises a combination of one or more transceivers and a wired network adapter, or similar wired device.

### Methods

FIG. 3 is a flow chart of a method for displaying data synchronization latency for a portable computing device 110 in accordance with some embodiments. In one embodiment, the steps illustrated by the method 300 shown by FIG. 3 are implemented by instructions for performing the described actions embodied or stored within a non-transitory computer readable storage medium that, when executed by a processor 210, provide the functionality further described below. Examples of a non-transitory computer readable storage medium, such as the storage device 220, include flash memory, random access memory (RAM) or any other suitable medium known to one skilled in the art.

The method 300 may be implemented in embodiments of hardware, software or combinations of hardware and software. In one embodiment, instructions for performing the actions described below are stored in the storage device 220 of the portable computing device 110, such as in the synchronization manager 222 and/or in the latency indicator generator 224, and execution of the instructions by the processor 210 performs the actions described below. Moreover, in some embodiments, the method 300 includes different and/or additional steps than those shown by FIG. 3.

The synchronization manager 222 included in the portable computing device 110 determines 305 a synchronization latency for the portable computing device 110. The synchronization latency describes the time delay separating data exchanges between the portable computing device 110 and a server 120 or a content provider 130. In one embodiment, the synchronization manager 222 determines 305 the synchronization latency based on the availability of a network 140 to the portable computing device 110 and the type of synchronization performed by the portable computing device 110. An example of determining 305 the synchronization latency is further described below in conjunction with FIG. 4.

The latency indicator generator 224 receives the synchronization latency from the synchronization manager 222 and generates 310 a synchronization latency indicator visually representing the synchronization delay. In one embodiment, the synchronization latency indicator may be displayed 310 concurrently with data from one or more applications, providing an indication of how recently the one or more applications exchanged data with a server 120 or a content provider 130. Alternatively, the synchronization latency indicator may be displayed 310 independently of data from one or more applications to provide more general information of the time until a data exchange with a server 120 or a content provider 130.

In one embodiment, the latency indicator generator 224 generates 310 a count down timer or a count up timer indicating the time, determined by the synchronization latency, until a data exchange between the portable computing device 110 and a server 120 or a content provider 130. In another embodiment, the latency indicator generator 224 generates an alternative representation of the calculated synchronization delay, such as an image changing in appearance as the time until a data exchange with a server 120 or with a content provider 130, as specified by the synchronization latency, decreases. For example, the latency indicator generator 224 generates 310 a rectangular area that is filled as the time until a data exchange with a server 120 or with a content provider 130 decreases. Alternatively, the latency indicator generator 224 generates 310 an image or textual representation of the synchronization latency. In other embodiments, the latency indicator generator 224 generates another suitable representation of the calculated synchronization latency, such as an image whose appearance is modified as the time until a data exchange with a server 120 or with a content provider 130 decreases.

The latency indicator generator 224 then communicates the synchronization latency indicator to the display device 240, which displays 315 the synchronization latency indicator. Displaying 315 the synchronization latency indicator provides a user of the portable computing device 110 with an expectation of the latency in exchanging data between the portable computing device 110 and the server 120 or the content provider 130. The displayed synchronization latency indicator also provides a user with an indication of how current the data stored by the portable computing device 110 is relative to the data stored by a server 120 or a content provider 130. Based on the synchronization latency indicator, a user may modify the synchronization type or manually initiate a data exchange between portable computing device 110 and the server 120 or the content provider 130 to expedite data synchronization.

In one embodiment, an input device 230 of the portable computing device 110 receives 320 an interaction with the displayed synchronization latency indicator. Responsive to the received interaction, the synchronization manager 222 retrieves synchronization detail data. For example, a portable computing device 110 contacts a region of a touch-sensitive display displaying the synchronization latency indicator, and the interaction with the synchronization latency indicator is communicated to the processor, which causes the synchronization manager 222 to communicate synchronization detail data to a display device 240 for display 325 to a user. In one embodiment, the synchronization detail data describes a current synchronization type, an elapsed time from a prior exchange of data between the portable computing device 110 and a server 120 or content provider 130 to the current time and/or other synchronization settings. In another embodiment, the synchronization detail data displays 325 an indication of an estimated time until a network 140 is accessible to the portable computing device 110 for synchronization. The synchronization detail data may also include a synchronization initiator to enable manual initiation of a data exchange between the portable computing device 110 and a server 120 by interacting with the synchronization initiator.

FIG. 4 is a flow chart of a method for determining 305 data synchronization latency of a portable computing device 110 in accordance with some embodiments. In one embodiment, the steps illustrated by the method shown by FIG. 4 are implemented by instructions for performing the described actions embodied or stored within a non-transitory computer readable storage medium that, when executed by a processor 210, provide the functionality further described below. Examples of a non-transitory computer readable storage medium, such as the storage device 220, include flash memory, random access memory (RAM) or any other suitable medium known to one skilled in the art.

The method shown in FIG. 4 may be implemented in embodiments of hardware, software or combinations of hardware and software. In one embodiment, instructions for performing the actions described below are stored in the storage device 220 of the portable computing device 110, such as in the synchronization manager 222, and execution of the instructions by the processor 210 performs the actions described below. Moreover, in some embodiments, the method includes different and/or additional steps than those shown by FIG. 4.

The synchronization manager 222 determines 405 whether a network 140 is available to a communication unit 260 included in the portable computing device 110. For example, a processor 210 executes instructions stored in the synchronization manager 222 to determine whether the communication unit 260 is receiving and/or transmitting data via the network 140. In determining 405 whether the network 140 is accessible, the synchronization manager 222 also determines whether the communication unit 260 is powered on or powered off and determines 405 that the network 140 is not available if the communication unit 260 is powered off.

Responsive to determining 405 the network 140 is not available, the synchronization manager 222 calculates 410 an estimated time until the network 140 is available. In one embodiment, the synchronization manager 222 retrieves data from the storage device 110 describing historical network usage statistics at various locations and obtains the location of the portable computing device 110 from an input device 230 or sensor included in the portable computing device 110. The synchronization manager 222 may also use data from a sensor describing movement of the portable computing device 110 to estimate the time until the portable computing device 110 reaches a location associated with stored network quality equaling or exceeding a threshold value based on a rate of movement of the portable computing device 110.

After calculating 410 the estimated time to network availability, or responsive to determining 405 the network 140 is available, the synchronization manager 222 determines 415 the type of synchronization performed by the portable computing device 110. In one embodiment, the synchronization manager 222 retrieves stored data identifying the type of synchronization performed by the portable computing device. For example, data in the synchronization manager 222 specifies whether the portable computing device is using push-based or pull-based synchronization. In one embodiment, the synchronization manager 222 also determines 420 data synchronization timing from stored data. For example, the synchronization manager 222 determines 420 the time interval between transmission of requests for data from the portable computing device 110 to a server 120 or to a content provider 130. As another example, the synchronization manager 222 determines timestamps when the portable computing device 110 received data from a server 120 and/or a content provider 130 or transmitted data to a server and/or a content provider 130.

### Example Use

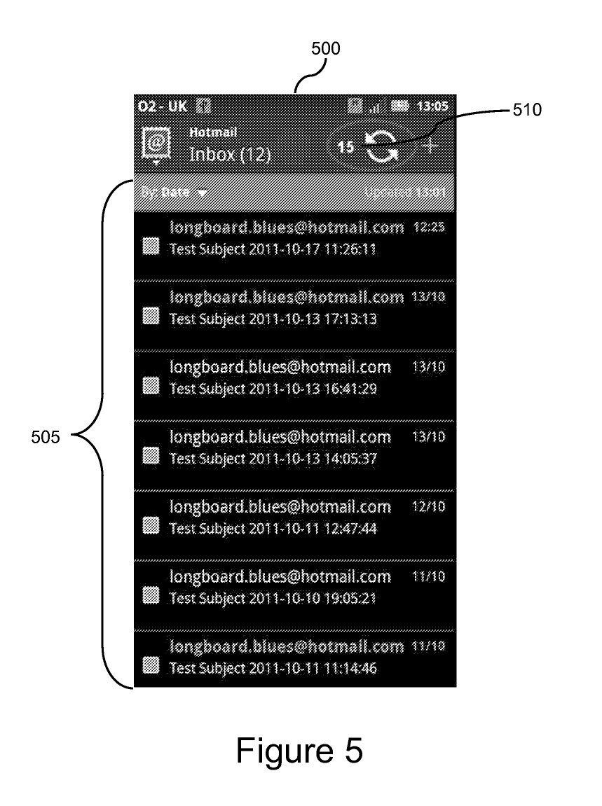

FIG. 5 is an example of a user interface 500 displaying data synchronization latency in accordance with some embodiments. The user interface 500 is displayed on a display device 240 of a portable computing device 110 or another suitable device visually displaying data from the portable computing device 110.

In the example shown by FIG. 5, the user interface 500 displays application data 505 in conjunction with a synchronization latency indicator 510. For example, the user interface 500 displays e-mail messages, or portions of e-mail messages, in an e-mail client. In FIG. 5, the displayed synchronization latency indicator 510 displays the time until the e-mail client synchronizes data with a server 120. For example, the synchronization latency indicator 510 in FIG. 5 indicates that the e-mail client will exchange data with a server 120 in 15 minutes. While FIG. 5 depicts the synchronization latency indicator 510 displaying alphanumeric data to describe the time until data synchronization, in other embodiments, an image or a sequence of images may be displayed to identify the time until a data exchange with a server 120.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “ha . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. In some embodiments, a combination of the two approaches may be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions, programs and/or integrated circuits with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
determining a synchronization latency describing a time interval until a portable computing device exchanges data with a server;
generating a synchronization latency indicator providing a visual representation of the synchronization latency; and
displaying the synchronization latency indicator.

2. The method of claim 1, further comprising:
receiving an interaction with the synchronization latency indicator; and
responsive to receiving the interaction, displaying synchronization detail information describing data exchange between the portable computing device and the server.

3. The method of claim 2, wherein displaying synchronization detail information describing data exchange between the portable computing device and the server comprises:
displaying a type of data exchange between the portable computing device and the server; and
displaying a time elapsed from a current time to a prior data exchange between the portable computing device and the server.

4. The method of claim 2, wherein displaying synchronization detail information describing data exchange between the portable computing device and the server comprises:
displaying an estimated time until a network is available to the portable computing device.

5. The method of claim 2, further comprising
displaying a type of data exchange between the portable computing device and the server;
displaying a synchronization initiator; and
responsive to receiving an interaction with the synchronization initiator, exchanging data between the portable computing device and the server.

6. The method of claim 1, wherein displaying the synchronization latency indicator comprises:
displaying a count down timer indicating a time until the portable computing device exchanges data with the server.

7. The method of claim 1, wherein displaying the synchronization latency indicator comprises:
modifying an appearance of a displayed image responsive to a decrease in time or an increase in time until a data exchange between the portable computing device and the server.

8. The method of claim 1, wherein displaying the synchronization latency indicator comprises:
displaying an alphanumeric representation of the synchronization latency.

9. The method of claim 1, wherein displaying the synchronization latency indicator comprises:
generating a tone or haptic feedback responsive to the synchronization latency equaling a threshold value.

10. The method of claim 1, wherein determining the synchronization latency describing the time interval until the portable computing device exchanges data with the server comprises:
determining whether a network is available to the portable computing device;
determining a type of data exchange between the portable computing device and the server; and
determining the time interval used by the type of data exchange.

11. The method of claim 10, further comprising:
responsive to determining the network is not available to the portable computing device, calculating an estimated time until the network is available to the portable computing device.

12. An apparatus comprising:
a processor;
a display device coupled to the processor;
a non-transitory computer readable storage device coupled to the processor and to the display device, the non-transitory computer readable storage device including instructions that, when executed by the processor, cause the processor to:
determine a synchronization latency describing a time interval until an exchange of data with a server;
generate a synchronization latency indicator providing a visual representation of the synchronization latency; and
display the synchronization latency indicator on the display device.

13. The apparatus of claim 12, wherein the non-transitory computer readable storage device further includes instructions that, when executed by the processor, cause the processor to:
receive an interaction with the synchronization latency indicator; and
responsive to receiving the interaction, display synchronization detail information describing the exchange of data with the server on the display device.

14. The apparatus of claim 13, wherein display the synchronization latency indicator on the display device comprises:
displaying a type of data exchange with the server on the display device; and
displaying a time elapsed from a current time to a prior data exchange with the server on the display device.

15. The apparatus of claim 13, wherein display synchronization detail information describing the exchange of data with the server on the display device comprises:
displaying an estimated time until a network is available.

16. The apparatus of claim 13, wherein the non-transitory computer readable storage device further includes instructions that, when executed by the processor, cause the processor to:
display a type of data exchange with the server on the display device;
display a synchronization initiator on the display device; and
responsive to receiving an interaction with the synchronization initiator, exchange data with the server.

17. The apparatus of claim 12, wherein display the synchronization latency indicator on the display device comprises:
displaying, on the display device, a count down timer indicating a time until the exchange of data with the server.

18. The apparatus of claim 12, wherein display the synchronization latency indicator on the display device comprises:
modifying an appearance of an image displayed on the display device responsive to a decrease in time until the exchange of data with the server.

19. The apparatus of claim 12, wherein display the synchronization latency indicator on the display device comprises:
displaying an alphanumeric representation of the synchronization latency on the display device.

20. The apparatus of claim 12, wherein determine the synchronization latency describing the time interval until the exchange of data with the server comprises:
determining whether a network is available;
determining a type of data exchange with the server; and
determining the time interval used by the type of data exchange.

21. The apparatus of claim 20, further comprising:
responsive to determining the network is not available, calculating an estimated time until the network is available.

22. A non-transitory computer readable storage medium coupled to a processor, the non-transitory computer readable storage medium including instructions that, when executed by the processor, cause the processor to:
determine a synchronization latency describing a time interval until an exchange of data with a server;
generate a synchronization latency indicator providing a visual representation of the synchronization latency; and
display the synchronization latency indicator on a display device.

23. The non-transitory computer readable storage medium of claim 22, wherein display the synchronization latency indicator on the display device comprises:
displaying, on the display device, a count down timer indicating a time until the exchange of data with the server.

24. The non-transitory computer readable storage medium of claim 22, wherein display the synchronization latency indicator on the display device comprises:
modifying an appearance of an image displayed on the display device responsive to a decrease in time until the exchange of data with the server.

25. The non-transitory computer readable storage medium of claim 22, wherein display the synchronization latency indicator on the display device comprises:
displaying an alphanumeric representation of the synchronization latency on the display device.

26. The non-transitory computer readable storage medium of claim 22, wherein determine the synchronization latency describing the time interval until the exchange of data with the server comprises:
determining whether a network is available;
determining a type of data exchange with the server; and
determining the time interval used by the type of data exchange.
